(19) United States
(12) Patent Application Publication
(10) Pub. No.: US 2026/0339707 A1
(43) Pub. Date: Oct. 29, 2026

(54) Memory-Governed System for Admissible State Constitution with Freeze-Based State Definition and Reconstructable Lineage

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/675,316

(22) Filed: May 12, 2026

(51) Int. Cl. G06F 9/48

(52) U.S. Cl. CPC G06F 9/4881

(57) ABSTRACT

A system for governing participation of representations in system behavior is provided. Representations are evaluated under anchoring constraints including timestamps, identifiers, and structural content and correspond to admissible representations defined under admissibility conditions including structural correspondence, temporal consistency, identity continuity, and reconstructable consistency with anchored memory states. Admissible representations are associated with temporally validated freeze events defining authoritative system states anchored within a validated memory domain. System validity is defined through reconstructable consistency across temporally validated state-transition events forming a lineage structure. Probabilistic measures do not determine admissibility or system state constitution. Behavior is constituted through governed admission of states rather than probabilistic output selection.

### CROSS-REFERENCE TO RELATED APPLICATIONS

This application is not based on and does not claim priority to any previously filed application. The Applicant is not aware of any prior public disclosure of the subject matter disclosed herein. The present application is self-contained and does not rely on incorporation by reference for enablement or support.

### PRIOR ART

The references listed below correspond to publicly available patent documents.

The inclusion of any reference herein is not an admission that such reference is material to patentability, is relevant to the claimed subject matter, or constitutes prior art against the present disclosure.

None of the listed references is believed to disclose or render obvious a system in which system behavior is constituted solely through admissible structural participation within a validated memory domain, with freeze-based state definition and reconstructable lineage.

US PATENT DOCUMENTS

| | |
|---|---|
| U.S. Pat. No. 12,141,692 B2 | November 2024 Karunaratne et al. |
| U.S. Pat. No. 10,885,426 B2 | January 2021 Santoro et al. |
| U.S. Pat. No. 11,080,594 B2 | August 2021 Sutskever et al. |
| U.S. Pat. No. 11,803,737 B2 | October 2023 Bohnstingl et al. |
| US 2020/0090035 A1 | March 2020 Thathachar et al. |
| U.S. Pat. No. 11,977,967 B2 | May 2024 Wayne et al. |
| U.S. Pat. No. 11,003,865 B1 | May 2021 Lee et al. |
| U.S. Pat. No. 12,353,469 B1 | July 2025 Mahabadi et al. |
| US 2025/0238613 A1 | July 2025 Isaacs |
| U.S. Pat. No. 12,450,494 B1 | October 2025 Mysore et al. |
| U.S. Pat. No. 12,111,754 B1 | October 2024 Mysore et al. |
| US 2024/0305465 A1 | September 2024 Vahldiek-Oberwagner |
| | et al. |
| U.S. Pat. No. 10,990,901 B2 | April 2021 Deo et al. |
| US 2025/0238811 A1 | July 2025 Cleveland et al. |
| U.S. Pat. No. 12,524,508 B2 | January 2026 Jeyashekar et al. |
| US 2021/0174205 A1 | June 2021 Rosa et al. |
| U.S. Pat. No. 12,468,856 B2 | November 2025 Adebayo et al. |
| US 2021/0110287 A1 | April 2021 Perov et al. |

FOREIGN PATENT DOCUMENTS

| | |
|---|---|
| WO 2023/014985 A1 | February 2023 Mueck et al. |

### OTHER PUBLICATIONS

Lewis, et al. “Retrieval-augmented generation for knowledge-intensive nlp tasks.” Advances in neural information processing systems 33 (2020): 9459-9474.
Tan, et al. “Reimagining retrieval augmented language models for answering queries.” Findings of the Association for Computational Linguistics: ACL 2023. 2023.
Zakka, et al. “Almanac-retrieval-augmented language models for clinical medicine.” Nejm ai 1.2 (2024): Aloa2300068.
Zhou, et al. “Metacognitive retrieval-augmented large language models.” Proceedings of the ACM Web Conference 2024. 2024.

### BACKGROUND OF THE INVENTION

Conventional systems rely on probabilistic inference, retrieval-based augmentation, ranking mechanisms, caching structures, provenance tracking, replay mechanisms, and trace-based validation to generate operational outputs. Such systems treat generated outputs, retrieved data, confidence scores, probabilistic rankings, or historical traces as operationally usable results without determining whether a representation qualifies as a valid authoritative system state. Existing retrieval systems, vector databases, semantic memory structures, replay systems, provenance repositories, logging systems, audit-history structures, and context-window augmentation mechanisms may preserve historical information or support probabilistic retrieval but do not define admissibility-governed authoritative state constitution within system behavior. Existing traceability and provenance systems record activity histories yet fail to establish reconstructable admissible-state consistency relative to anchored admissible states. Conventional memory structures function as storage, caching, retrieval augmentation, replay support, or probabilistic retrieval mechanisms and do not operate as validated memory domains comprising anchored admissible states associated with freeze-defined authoritative admissible system states. Existing systems therefore remain vulnerable to probabilistic drift, replay inconsistency, non-authoritative state reuse, non-admissible state participation, and non-reconstructable operational continuity. Accordingly, a system is required in which admissibility conditions determine whether representations are admitted into system behavior through freeze-defined admissible-state constitution, anchored admissible-state participation, lineage-chain continuity, and reconstructable admissible-state consistency within a validated memory domain.

### SUMMARY OF THE INVENTION

The present disclosure defines a memory-governed system in which system behavior is defined through admissibility-governed participation of freeze-defined admissible system states anchored within a validated memory domain rather than probabilistic output selection, replay reconstruction, retrieval ranking, provenance tracking, or confidence-based validation. One or more representations corresponding to governed fact expressions are evaluated under anchoring constraints including timestamps, identifiers, contextual attributes, and structural content. A validated memory domain comprises anchored admissible states associated with temporally validated freeze events defining authoritative admissible system states. Admissibility conditions comprise temporal consistency, identity continuity, structural correspondence, and reconstructable consistency relative to anchored admissible states within the validated memory domain. Representations satisfying admissibility conditions are admitted as admissible representations and associated with freeze-defined authoritative admissible system states for participation within system behavior. Candidate representations lacking admissibility are not admitted as valid system states. System validity is defined through reconstructable admissible-state consistency across temporally validated state-transition events forming lineage chains enabling deterministic reconstruction of admissible system states. Probabilistic measures, rankings, confidence values, retrieval priority values, replay structures, provenance structures, or statistical likelihoods do not independently determine admissibility, authoritative state constitution, or system validity and exist only as auxiliary attributes associated with representations satisfying admissibility conditions. The validated memory domain does not correspond to a cache, vector database, semantic retrieval store, replay structure, provenance repository, logging repository, or context-window augmentation memory, but instead operates as a validated admissible-state domain governing admissible participation within system behavior through anchored admissible-state continuity and reconstructable lineage consistency.

### BRIEF DESCRIPTION OF DRAWINGS

FIG. 1—Core System Constitutional Domain

FIG. 2—Correspondence and Admissibility Structure

FIG. 3—Freeze Event and Admissible State Constitution

FIG. 4—Temporal Lineage Structure

FIG. 5—System Validity and Structural Exclusion

### DETAILED DESCRIPTION OF THE INVENTION

The following description defines structural relationships of a memory-governed system in which system behavior is defined through admissibility-governed participation of admissible representations associated with anchored admissible states within a validated memory domain. All described elements correspond to admissibility conditions, anchored admissible-state continuity, freeze-defined authoritative admissible system states, lineage-chain relations, reconstructable admissible-state consistency, and deterministic system validity. The disclosed structures do not correspond to probabilistic output ranking, generalized workflow orchestration, replay reconstruction, provenance tracking, historical logging, semantic retrieval augmentation, cache-based retrieval mechanisms, or probabilistic retrieval systems. A validated memory domain comprises anchored admissible states associated with temporally validated freeze events defining authoritative admissible system states. Candidate representations generated within a representation domain do not independently constitute valid system states and are not admitted into system behavior absent admissibility determination under anchoring constraints. Admissibility conditions determine whether a representation participates within system behavior as an admissible system state. Lineage chains comprise temporally validated state-transition events enabling reconstructable admissible-state consistency relative to anchored admissible states within the validated memory domain. System validity is defined through deterministic reconstructable consistency of admissible system states rather than probabilistic confidence, replay reconstruction, provenance replay, logging reconstruction, or ranking-based output selection. All disclosed elements form a non-separable admissibility-governed architecture, and no individual element independently defines authoritative system-state participation outside the validated memory domain.

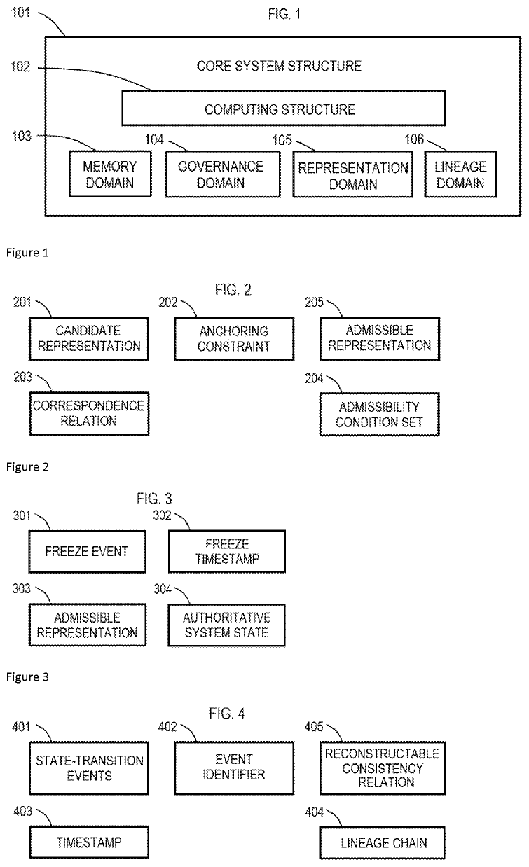

### FIG. 1—Core System Constitutional Domain

A system structure 101 is defined as a unified structural domain.

A computing structure 102 is defined within system structure 101 and comprises at least one processor and at least one memory.

A memory domain 103, a governance domain 104, a representation domain 105, and a lineage domain 106 are defined within system structure 101.

Memory domain 103 corresponds to a validated structured portion of the at least one memory in which anchored, previously validated system states exist.

Governance domain 104 corresponds to structural definitions including anchoring constraints, admissibility conditions, and temporal validation conditions.

Representation domain 105 corresponds to structural entities including candidate representations and admissible representations.

Lineage domain 106 corresponds to structural elements including temporally validated state-transition events forming lineage.

Domains 103-106 exist as structurally related domains defined by correspondence, admissibility, and temporal constraint relationships.

### FIG. 2—Correspondence and Admissibility Structure

A candidate representation 201 is defined within representation domain 105.

Anchoring constraints 202 and an admissibility condition set 204 are defined within governance domain 104.

A correspondence relation 203 is defined as a structural relation between representations within representation domain 105 and memory domain 103 under anchoring constraints 202.

An admissible representation 205 is defined as a representation that corresponds to memory domain 103 under correspondence relation 203 and is associated with satisfaction of admissibility condition set 204.

Representations lacking anchoring constraints 202, lacking correspondence relation 203, or lacking association with admissibility condition set 204 correspond to non-admission as valid system states within system behavior.

### FIG. 3—Freeze Event and Admissible State Constitution

A freeze event 301 and a freeze timestamp 302 are defined within governance domain 104.

An admissible representation 303 is defined within representation domain 105.

Elements 301, 302, and 303 exist as structurally associated elements that define an authoritative admissible system state 304.

Admissible representation 303 is structurally immutable relative to its associated freeze event 301 and freeze timestamp 302.

Any modification corresponds to a distinct representation associated with a distinct temporally validated state-transition event 401.

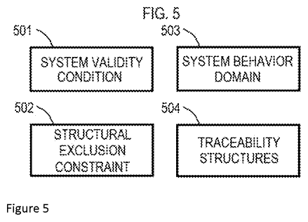

### FIG. 4—Temporal Lineage Structure

A set of temporally validated state-transition events 401 is defined within lineage domain 106.

Each state-transition event 401 is structurally associated with an event identifier 402 and a timestamp 403.

A lineage chain 404 is defined as a structurally related set of temporally validated state-transition events 401.

A reconstructable consistency relation 405 is defined between admissible representations defined within representation domain 105 and memory domain 103 through lineage chain 404.

Lineage chain 404 constitutes the structural basis for deterministic reconstruction of system states relative to memory domain 103.

Representations lacking structural inclusion within lineage chain 404 correspond to non-admission as valid system states within system behavior.

### FIG. 5—System Validity and Structural Exclusion

A system validity condition 501 is defined as a structural relation corresponding to reconstructable consistency between admissible representations defined within representation domain 105 and anchored validated memory states within memory domain 103.

A structural exclusion constraint 502 corresponds to non-admission of representations lacking anchoring constraints 202, lacking correspondence relation 203, lacking association with admissibility condition set 204, lacking association with freeze event 301, or lacking inclusion within lineage chain 404.

A system behavior domain 503 is defined within system structure 101 as a structural domain corresponding to participation of admissible representations within representation domain 105.

Traceability structures 504 correspond to auxiliary structural elements independent from lineage constitution and system validity, and do not define admissibility or system validity.

The present description defines structural relationships of a memory-governed system in which system behavior is structurally defined through admissible structural participation of representations within a validated memory domain. All described elements correspond to structural existence, admissibility conditions, temporal constraints, and lineage constitution, and do not correspond to procedural steps, execution sequences, algorithmic pipelines, routing logic, or decision-making processes. All structures form a non-separable unified system, and no element independently defines system behavior outside structural admissibility within the validated memory domain. References to generation, validation, evaluation, admission, or reconstruction denote structural relations and conditions rather than ordered operations.

One or more inputs of any form are expressed as representations capable of structural participation within a representation domain. Each representation corresponds to a governed fact expression that is structurally comparable under anchoring constraints comprising temporal attributes, content structure, identifiers, and contextual conditions. A representation exists as a structural entity independent of its origin, including representations corresponding to memory states or representations corresponding to outputs of a generation structure. System participation is defined by admissibility within the validated memory domain rather than by the origin of the representation.

A validated memory domain is defined as a structured portion of memory comprising anchored, previously validated system states. Each anchored state is associated with a temporally validated event including an identifier and a timestamp. An anchored state is defined by association with a freeze event and constitutes an authoritative admissible system state. The validated memory domain operates as a domain of admissible states and does not correspond to a cache, a general-purpose database, a probabilistic retrieval store, or a repository of unverified data, semantic retrieval storage, inference-extension memory, or context-window augmentation memory. A correspondence relation between a representation and the validated memory domain is defined under anchoring constraints, and such correspondence structurally determines admissibility without requiring generation.

Where correspondence to the validated memory domain is not established, one or more candidate representations correspond to representations produced by a generation structure within the representation domain. Candidate representations may exist as a plurality of structurally distinct representations within a defined temporal context. Candidate representations do not constitute system states and are not admitted as valid system states within system behavior absent admissibility. The existence of multiple candidate representations corresponds to structural variability and does not imply probabilistic selection of system states.

A governance domain defines admissibility as a structural condition of participation. Admissibility conditions comprise anchoring constraints, structural correspondence conditions, temporal consistency conditions, identity continuity conditions, and reconstructable consistency with anchored memory states. A representation corresponding to these conditions is defined as an admissible representation. A representation lacking admissibility is not admitted as a valid system state within system behavior. Probabilistic measures, including confidence or likelihood, may be structurally associated with representations as auxiliary attributes and do not determine admissibility or system state constitution.

Admissible representations may be structurally associated with measurable attributes including cross-modal consistency, temporal continuity, and reconstruction accuracy relative to anchored memory states. Such attributes characterize admissibility without defining it. Validation corresponds to structural characterization of admissible representations and does not constitute procedural filtering, ranking, or algorithmic selection.

An admissible representation is associated with a temporally validated freeze event comprising an event identifier and a validated timestamp. The freeze event defines an authoritative admissible system state constituting admissible system-state existence within system behavior. An admissible representation associated with a freeze event is structurally immutable relative to that event. Any modification corresponds to formation of a distinct representation associated with a distinct temporally validated state-transition event. The freeze event prevents state drift by fixing the representation to a temporally bound authoritative state.

An admitted representation associated with a freeze event is incorporated into the validated memory domain as an anchored state. Anchored states are reusable through correspondence under anchoring constraints. A representation corresponding to an anchored state is admitted through memory-first correspondence independently of the generation structure. The validated memory domain accumulates admissible system states and structurally governs subsequent participation.

Each admissible representation is associated with temporally validated state-transition events forming a lineage chain. A lineage chain comprises a structurally related set of events including identifiers and timestamps. Lineage is defined as reconstructable consistency of system states relative to the validated memory domain. Reconstruction of system states corresponds to structural traversal of temporally validated events. Lineage does not correspond solely to trace, logging, replay, historical recording, provenance metadata, or audit-history mechanisms.

System validity is defined as reconstructable consistency between admissible representations and anchored states within the validated memory domain. A representation lacking admissibility, lacking association with a freeze event, or lacking inclusion within a lineage chain is not admitted as a valid system state within system behavior. Traceability structures, including logs, traces, or provenance graphs, may exist as auxiliary elements and do not define admissibility or system validity.

Conventional systems rely on probabilistic output selection, retrieval-based augmentation, caching of generated outputs, and trace-based lineage. In the disclosed system, generated outputs correspond to candidate representations, admissibility defines whether a representation constitutes a system state, freeze events define authoritative system states, and lineage is defined as reconstructable consistency rather than trace. System behavior is constituted through governed admission of states rather than selection of outputs.

A set of heterogeneous inputs comprising imaging data, signal data, and sensor measurements is expressed as representations within the representation domain. Each representation is structurally associated with temporal attributes, identifiers, and content structure. A correspondence relation to the validated memory domain is defined under anchoring constraints including timestamps, content structure, identifiers, and contextual attributes.

Where correspondence is established, the representation corresponds to an anchored state within the validated memory domain. The anchored state is admitted as an admissible representation associated with a previously defined freeze event. The admitted representation constitutes an authoritative admissible system state and participates in system behavior independently of the generation structure.

Where correspondence is not established, a plurality of candidate representations corresponds to structurally distinct representations within the representation domain. The governance domain defines admissibility through structural correspondence, temporal consistency, identity continuity, and reconstructable consistency relative to anchored memory states. A representation corresponding to admissibility conditions is defined as an admissible representation and is associated with a temporally validated freeze event. The authoritative admissible system state is incorporated into the validated memory domain as an anchored state.

A set of inputs corresponds to representations exhibiting structural inconsistency, including divergence in temporal attributes, content structure, or identity continuity. Multiple candidate representations exist within the representation domain, each lacking correspondence to an anchored state and lacking reconstructable consistency.

Within the governance domain, admissibility conditions are not structurally satisfied due to absence of correspondence under anchoring constraints and absence of reconstructable consistency with anchored memory states. No representation corresponds to an admissible representation. No freeze event is associated with any candidate representation. The representations remain non-admitted and do not constitute valid system states within system behavior.

System behavior remains stable, and no non-reconstructable representation is incorporated into the validated memory domain.

A representation corresponding to a previously encountered structural condition is expressed within the representation domain. A correspondence relation to an anchored state in the validated memory domain is defined under anchoring constraints including timestamps, identifiers, and content structure.

The anchored state is admitted as an admissible representation independently of formation of candidate representations by the generation structure. The admitted representation corresponds to an authoritative admissible system state defined by a freeze event. The validated memory domain provides structural reuse of the anchored state, preserving reconstructable consistency.

A representation corresponding to a given context is associated with a plurality of candidate representations exhibiting structural variability in content and temporal attributes. Within the governance domain, admissibility is defined through structural correspondence and reconstructable consistency relative to anchored memory states.

A representation corresponding to admissibility conditions is defined as an admissible representation and is associated with a temporally validated freeze event defining an authoritative admissible system state. Subsequent variability corresponds to distinct representations associated with distinct temporally validated events. The lineage domain comprises distinct states, and drift is structurally contained through freeze-based state constitution.

An admissible representation is associated with a lineage chain comprising temporally validated state-transition events. Each event includes an identifier and a timestamp and corresponds to a structural relation.

Reconstruction of the admissible representation corresponds to traversal of the lineage chain, and the reconstructed representation corresponds to an anchored state through reconstructable consistency. Lineage is defined as a structural relation enabling reconstruction independent of trace or logging mechanisms.

A representation context corresponds to a plurality of candidate representations within the representation domain. Each candidate representation corresponds to a structurally distinct expression.

The governance domain defines admissibility through structural correspondence, temporal consistency, identity continuity, and reconstructable consistency. A representation corresponding to admissibility conditions is defined as an admissible representation and is associated with a freeze event defining an authoritative admissible system state. Other representations lacking admissibility remain non-admitted.

Representations originating from distinct contexts correspond to structural relations evaluated under anchoring constraints and lineage relations. Continuity is defined through reconstructable consistency with anchored memory states.

A representation corresponding to continuity and admissibility is defined as an admissible representation and is associated with a freeze event. The resulting anchored state preserves structural continuity across contexts.

A representation lacking anchoring constraints, correspondence to the validated memory domain, admissibility conditions, association with a freeze event, or inclusion within a lineage chain is structurally excluded from system participation.

Such a representation remains non-admitted and does not constitute a valid system state. Structural exclusion preserves system validity.

1. A system for governing participation of representations in system behavior, comprising:
at least one processor and at least one memory;
a validated memory domain stored in the at least one memory and comprising anchored admissible states associated with temporally validated events;
a generation structure corresponding to formation of one or more candidate representations from one or more inputs, wherein the generation structure does not independently determine admissibility or system-state participation;
and a governance structure structurally configured to evaluate correspondence of the one or more candidate representations to the validated memory domain under anchoring constraints including timestamps, content structure, contextual attributes, and identifiers, and to determine admissibility based on conditions including temporal consistency, identity continuity, structural correspondence, and reconstructable consistency with anchored admissible states;
wherein a representation is admitted into system behavior only as an admissible representation satisfying the admissibility conditions;
wherein probabilistic measures, confidence values, rankings, likelihood values, or retrieval-priority values do not independently determine admissibility or authoritative system-state constitution and are used only as auxiliary attributes associated with admissible representations;
wherein an admissible representation is associated with a temporally validated freeze event including a validated timestamp defining a freeze-defined authoritative admissible system state for participation within system behavior;
wherein admitted representations are incorporated into the validated memory domain as anchored admissible states for subsequent admissibility-governed reuse; and
wherein system validity and lineage are defined by reconstructable admissible-state consistency of admitted representations with anchored admissible states through temporally validated state-transition events enabling deterministic reconstruction of admissible system states.

2. The system of claim 1, wherein the system is configured to retrieve a representation from the validated memory domain when correspondence to an anchored state is established, independently of the generation structure.

3. The system of claim 1, wherein the generation structure is configured to operate when correspondence to the validated memory domain is insufficient.

4. The system of claim 1, wherein the generation structure produces a plurality of candidate representations within a defined temporal window under configurable parameters.

5. The system of claim 4, wherein the plurality of candidate representations is evaluated to identify a subset exhibiting consistency including one or more of convergence, variance reduction, or conflict resolution.

6. The system of claim 1, wherein admissibility determination comprises constraint evaluation and consistency evaluation, with probabilistic indicators used only as auxiliary factors.

7. The system of claim 1, wherein representations lacking admissibility or lacking association with a temporally validated event are not admitted as valid system states within system behavior.

8. A method for governing representations in a system, comprising:
receiving one or more inputs and forming one or more candidate representations;
evaluating correspondence of the candidate representations to a validated memory domain under anchoring constraints including timestamps, content structure, contextual attributes, and identifiers;
determining admissibility based on conditions including temporal consistency, identity continuity, structural correspondence, and reconstructable consistency with anchored admissible states;
defining a representation corresponding to satisfaction of the admissibility conditions as an admissible representation;
associating the admissible representation with a temporally validated freeze event including a validated timestamp defining a freeze-defined authoritative admissible system state;
incorporating the admissible representation into the validated memory domain as an anchored admissible state; and
determining system validity and lineage based on reconstructable admissible-state consistency through temporally validated state-transition events enabling deterministic reconstruction of admissible system states;
wherein probabilistic measures, rankings, likelihood values, or confidence values do not independently determine admissibility or authoritative system-state constitution.

9. The method of claim 8, further comprising generating a plurality of candidate representations within a defined temporal window.

10. The method of claim 9, further comprising evaluating stability of the candidate representations based on consistency measures including one or more of convergence, variance, or conflict.

11. The method of claim 8, wherein admissibility definition comprises constraint-based evaluation and consistency-based evaluation.

12. The method of claim 8, further comprising associating admitted representations with temporally validated state-transition events.

13. The method of claim 12, further comprising reconstructing system states through traversal of the temporally validated state-transition events.

14. The method of claim 8, wherein the freeze event stabilizes the admitted representation to prevent state drift.

15. A non-transitory computer-readable medium storing instructions that, when executed by at least one processor, cause a system to:
form one or more candidate representations from one or more inputs;
evaluate correspondence of the candidate representations to a validated memory domain under anchoring constraints including timestamps, content structure, contextual attributes, and identifiers;
determine admissibility based on conditions including temporal consistency, identity continuity, structural correspondence, and reconstructable consistency with anchored admissible states;
define a representation corresponding to satisfaction of the admissibility conditions as an admissible representation;
associate the admissible representation with a temporally validated freeze event including a validated timestamp defining a freeze-defined authoritative admissible system state;
incorporate the admitted representation into the validated memory domain as an anchored admissible state; and
determine system validity and lineage based on reconstructable admissible-state consistency through temporally validated state-transition events enabling deterministic reconstruction of admissible system states;
wherein probabilistic measures do not independently determine admissibility or authoritative system-state constitution.

16. The non-transitory computer-readable medium of claim 15, wherein admitted representations are associated with temporally validated events including event identifiers and timestamps.

17. The non-transitory computer-readable medium of claim 16, wherein the events form a lineage structure enabling reconstruction of system states.

18. The non-transitory computer-readable medium of claim 15, wherein admissible representations are immutable relative to associated freeze events and modifications correspond to distinct representations associated with distinct temporally validated events.

19. The non-transitory computer-readable medium of claim 15, wherein the freeze event defines an authoritative system state.

20. The non-transitory computer-readable medium of claim 15, wherein representations lacking inclusion within a lineage structure are not admitted as valid system states within system behavior.
